(19) United States
(12) Patent Application Publication
(10) Pub. No.: US 2015/0172311 A1
(43) Pub. Date: Jun. 18, 2015

(54) COLLABORATIVE SYSTEM FOR CYBER SECURITY ANALYSIS

(71) Applicant: Comilion Mobile Ltd., Tel Aviv (IL)

(72) Inventors: Kobi Freedman, Modi'in-Maccabim-Re'ut (IL); Guy Wertheim, Rishon LeZion (IL)

(21) Appl. No.: 14/571,035

(22) Filed: Dec. 15, 2014

Related U.S. Application Data
(60) Provisional application No. 61/915,533, filed on Dec. 13, 2013.

(51) Int. Cl. H04L 29/06

(52) U.S. Cl. CPC H04L 63/1441; H04L 63/20; H04L 63/1433

(57) ABSTRACT

Methods, systems, devices and computer program products provide a multi-user collaborative environment for malware and security threat analyses and mitigation. One methodology for collaborative evaluation of cyber security threats includes receiving information associated with a cyber activity that is indicative of a potential cyber attack, and processing the information at a first server of the collaborative cyber analysis system to incorporate share restriction rules that include rules based on specific regulations promulgated by a government or an international organization, rules based on a enterprise policy or rules that are set by a user that are specific to the information. The processed information is then transmitted to a second server of the collaborative cyber analysis system, where the second server is allowed to access at least a portion of the information associated with the cyber activity, the enhanced information, or the cyber security countermeasure subject to the share restriction rules.

### RELATED APPLICATIONS

This application claims priority to the provisional application with Ser. No. 61/915,533, titled “Multi-user collaborative environment for malware and security threats analysis and research,” filed Dec. 13, 2013. The entire contents of the above noted provisional application are incorporated by reference as part of the disclosure of this document.

### TECHNICAL FIELD

The subject matter of this patent document relates to cyber security and more specifically to analysis and mitigation of security threats in cyber space.

### BACKGROUND

The use of networked systems for processing, storage and control of digital data has proliferate in the past decades and has become an important part of our everyday lives. Such systems are currently integrated into many private industry and governmental services and products with wide-ranging applications in financial, energy, medical, entertainment, surveillance, military and other fields of endeavor. As the number of mobile users, digital applications, cloud computing resources and data networks grows, so does the opportunity for exploitation of the data that is often carried out as cyber attacks to disable or infiltrate those systems and networks. The vulnerability of the networked systems is evident by the prevalence of news reports related to networks outages, consumer data breaches, government and business systems that are compromised by hackers, computer viruses and other incidents that affect our lives, ranging from minor inconveniences to life-threatening scenarios.

Cybersecurity countermeasures have been developed for protection of assets, which includes data, consumer devices, servers, networks, buildings, as well as human lives. These countermeasures include access control, awareness training, audit, accountability, risk assessment, security assessment, authorization control and others. Once a set of countermeasures is deployed, however, the attackers are motivated to, and often do, defeat those countermeasures. An effective approach to cybersecurity thus becomes a process of continuously analyzing, identifying and mitigating on-going security threats.

### SUMMARY

The embodiments of the present document relate to systems and methods that allow a multi-user collaborative environment for malware and security threat analyses and mitigation. The disclosed technology further enables secured information sharing for security and fraud detection, mitigation, research and remediation.

One aspect of the disclosed embodiments relates to a method for collaborative evaluation of cyber security threats. Such a method includes receiving information associated with a cyber activity that is indicative of a potential cyber attack, processing the information at a first server of a collaborative cyber analysis system to at least incorporate share restriction rules with the information. The share restriction rules include one or more of: rules based on specific regulations promulgated by a government or an international organization, rules based on an enterprise policy or rules that are set by a user of collaborative cyber analysis system that are specific to the information. The method further includes transmitting, to at least a second server of the collaborative cyber analysis system, one or more of: (a) the information associated with the cyber activity, (b) an enhanced information related to identification or mitigation of the potential cyber security attack, or (c) a cyber security countermeasure, where the at least second server is allowed to access at least a portion of the one or more of the information associated with the cyber activity, the enhanced information, or the cyber security countermeasure subject to the share restriction rules.

In one exemplary embodiment, the share restriction rules are automatically applied to all data or messages related to the information that are transmitted from, or stored at, the first server so that at least one segment of the information, the enhanced information, or the cyber security countermeasure is not assessable to a first party while the at least one segment is accessible to a second party. In another exemplary embodiment, the processing of the information includes ascertaining at least one of an identity of a source of the potential cyber attack, the degree of damage to a networked computing system or to stored information that can be caused by the potential cyber attack, or a specific pattern of cyber activity associated with the potential cyber attack, and producing at least a portion of the enhanced information based on those ascertained items. In yet another exemplary embodiment where the cyber activity is associated with a software program, the processing of the information includes using a virtualization system to conduct a static analysis of the software program and a dynamic analysis of the software program, and combining a result of the static analysis and a result of the dynamic analysis to produce at least a portion of the enhanced information.

In another exemplary embodiment, one or more of the information associated with the cyber activity, the enhanced information, or the cyber security countermeasure is in a first format that is compatible with a first cyber security system, and the above noted method includes transmitting one or more of the information associated with the cyber activity, the enhanced information, or the cyber security countermeasure in the first format to the second server of the cyber analysis system, where one or more of the information, the enhanced information, or the cyber security countermeasure is translated to a second format that is compatible with a second cyber security system.

Another aspect of the disclosed embodiments relates to a system for collaborative evaluation of cyber security threats. Such a system includes a first server coupled to one or more computing devices of a first enterprise. The first server is further coupled to a communication network to receive information associated with a cyber activity that is indicative of a potential cyber attack. The first serve includes a processor (e.g., a processing component that is implemented at least partially using electronic circuits) to process the information to at least incorporate share restriction rules with the information. The share restriction rules include one or more of: rules based on specific regulations promulgated by a government or an international organization, rules based on a enterprise policy or rules that are set by a user of collaborative cyber analysis system that are specific to the information. Such a system additionally includes a second server coupled to the communication network to receive one or more of: (a) the information associated with the cyber activity, (b) an enhanced information related to identification or mitigation of the potential cyber security attack, or (c) a cyber security countermeasure. The second server is allowed to access at least a portion of the one or more of the information associated with the cyber activity, the enhanced information, or the cyber security countermeasure subject to the share restriction rules.

In one exemplary embodiment, the above noted system further includes a middleware component coupled to the communication network. The middleware component is configured to manage queuing of messages that are exchanged between the first server and other entities of the system, including the second server. Such messages can include one or more of the information associated with the cyber activity, the enhanced information, the cyber security countermeasure or any other messages or data. The middleware component can further be configured to, prior to routing the messages to the second sever, remove an identity associated with the information that is transmitted by the first server. In still another exemplary embodiment, the middleware component is configured to provide a directory of users, servers or enterprises associated with the system for collaborative evaluation of cyber security threats. In another exemplary embodiment, the middleware component includes an interlocking subcomponent to synchronize data amongst different servers, or different users of the system.

### BRIEF DESCRIPTION OF THE DRAWINGS

FIG. 1 provides a high level block diagram of a collaborative system for analysis and mitigation of cyber security threats in accordance with an exemplary embodiment.

FIG. 2 illustrates a block diagram of a middleware component in accordance with an exemplary embodiment.

FIG. 3 shows a simplified pattern of cyber activity that illustrates how the disclosed collaborative system can be used to address a practical problem that in faced many enterprises.

FIG. 4(A) is a simplified diagram that illustrates certain use restrictions that are incorporated with various data elements in accordance with an exemplary embodiment.

FIG. 4(B) is a simplified diagram that illustrates exemplary translation capabilities of the disclosed collaborative system for the data elements of FIG. 4(A).

FIG. 5 illustrates a block diagram of a device that can be implemented as part of the disclosed devices and systems.

FIG. 6 illustrates a set of exemplary operations that can be carried out to collaboratively evaluate cyber security threats in accordance with an exemplary embodiment.

### DETAILED DESCRIPTION

To implement effective cybersecurity countermeasures, the presence of an attack must be quickly detected, or better yet, forecasted through analysis of certain patterns of observed cyberspace activity, and then the knowledge gained through such analysis must be translated into prevention measures. A common practice of a security researcher is to explore the capabilities and behavior of a sample file of a malware, or other potential threat, in an isolated examination environment where the sample file can be examined both dynamically (e.g. sand boxing) and statically (e.g. static analysis)—a situation which allows a sample software to be executed or analyzed without affecting a real computer or network system. A sandbox is a security mechanism for separating programs from other components of the system. It is often used to execute untested or suspicious code that may have originated from unverified third parties, suppliers, users or websites. The sandbox typically provides a tightly controlled set of resources for programs to be executed, including memory and network access (if needed). The sandbox also provides the ability to inspect the suspect program without allowing the program to harm the host device.

Sandboxing can be considered a specific example of virtualization, which refers to creating a virtual, as opposed to an actual, version of a software, hardware platform, operating system, computer network resources or other components and elements. In some contexts, virtualization allows interactions with a logical version of a keyboard, a hardware component, a memory space, a database and the like. For example, network virtualization creates a virtualized network with addressing space within or across network subnets, and memory virtualization aggregates memory resources from networked systems into appear to be, and are useable as, a single memory pool.

Currently, many organizations and governments dedicate vast amounts of time and money to analyzing various cybersecurity attacks and establishing short-lived countermeasures. While individual researchers or organizations may have access to certain research and analysis tools, cybersecurity analysis that leads to the establishment of effective countermeasures is very difficult task partly due to the enormous volume of cyber traffic, globalization of computer networks, and availability of computer resources to smart hackers (or hostile governments). This challenge is evident by many reports of data breaches and network outages that are commonplace at financial institutions, retail stores, and even governmental agencies that employ a large number of security experts. In fact, while every enterprise significantly invests in security, 94% of the enterprises being compromised learn about it from someone outside the enterprise and not by themselves.

One aspect of the disclosed embodiment relates to providing a multi-user and collaborative ecosystem that enables efficient and secure identification and mitigation of cyberspace security attacks, including malware that can contaminate a networked system and/or gain access to unauthorized data. The disclosed embodiments further enable collaboration and crowdsourcing, which facilitates solicitation of contributions and cooperation, as well as analysis and identification of cyberspace threats using professionals that may be dispersed throughout different geographic regions and time zones. The disclosed collaborative systems and infrastructures enable accumulative decision making and sharing of professional knowledge to produce much more accurate and efficient methods for combating cyberspace attacks in comparison to decisions made by individuals or individual organizations. Such a system takes advantage of different skills and expertise, prior know-how and trial and error processes performed by many expert users of the system in order to fully understand the capabilities of a cyber threat (e.g., a file sample) and present viable solutions to neutralize the security threat.

Such a collaborative system enables quick identification of malicious software or other cyber security threats that may occur at any time and against any target. Examples of such malicious software include viruses, worms, Trojan horses, ransomware (e.g., a type of malware which restricts access to the computer system that it infects, and demands a ransom paid in order for the restriction to be removed), spyware, adware, scareware (e.g., a scam software with malicious payload, usually of limited or no benefit, that is sold to consumers via certain unethical marketing practices) or variations thereof. A cyber attack is generally identified as a type of offensive maneuver that targets computer information systems, infrastructures, computer networks, and/or personal computer devices through malicious acts, which can originate from an anonymous source, and attempts to steal, alter, or destroy a specified target by hacking into or disabling a susceptible system. For example, cyber attacks can range from installing spyware on a PC to attempts to destroy the infrastructure of an entire nation.

By analyzing particular cyberspace activities, determining the relevancy and risk of such activities, and introducing countermeasures and mitigating actions to neutralize or thwart such attacks, the collaborative network and systems of the disclosed embodiments can avert attacks on financial sector data, medical records, energy distribution networks, intelligence gathering networks and other networks and systems that have significant financial, social and national security consequences. The unique platform that is described in this document provides an ideal ecosystem for evaluation, research and detection of cyber attack indicators in a secured environment which can serve multiple users at the same time. The disclosed systems thus provide a secured data environment which can be researched and shared among users in a secure and safe manner.

In one embodiment, the collaborative system includes a virtualization system that enables execution, research and analysis of a sample software. The virtualization environment allows multiple users of the system to simultaneously conduct their separate and/or collaborative analysis of the software or the cyber threat. Such a virtualization system can, for example, be a cloud-based virtualization platform that can simulate different architectures. The collaborative system includes mechanisms to combine dynamic and static analysis of cyber threats. Static analysis involves the analysis of potential cyber threat software source or binary code to ascertain the contents and operations of the code without actually executing the code. Dynamic analysis, on the other hand, involves executing or running the code in a controlled environment (e.g., sandbox) in a manner that the codes malicious behavior can be ascertained without affecting the components of a real system. The result of static and dynamic analyses can, for example, describe patterns of malicious or suspected behavior that allow the data indicators gathered from the analysis (e.g. digital file signatures, IP, URL address etc.) to be compared with known prior intelligence.

One component of the collaborative system allows a user self-expansion of analysis methods of software threats in isolated environments. The system also includes a back-office server/system, that among other functionalities, enables mass collection and analysis of cyber attack indicators and other data. In one implementation, the system uses a cloud-based web platform for cyber collaboration, research and analysis. The system also includes a device based application for monitoring, scanning, reviewing and managing telemetries of mobile applications and devices. The system also includes one or more application program interfaces (APIs). In particular, the system includes an integration API that allows communication with security providers, and an integration API for communication with data probing developers. The system also includes a mechanism for deploying data filters, indicators and signatures into an on premise indicator database of an enterprise.

Various features of the disclosed multi-user collaborative system includes a process for collecting accumulative results of many user's inspections, as well as a process for online sharing of research data between many researchers in a unified virtualization environment. The disclosed system includes components for securely integrating research results with external databases. The system also allows for automatic generation of a risk profile for specific types of threats that can be based on many factors, such as prior researches, which allows for automatic updates of all relevant users on the profile. The system further can create static signatures for various samples, which can be based in-part on user analysis and capabilities, and building blocks that have created by the users of the system. Such a multi-user environment allows for code scanning and review.

Other features of the disclosed system includes evaluating security threat relevancy and severity based on, e.g., social ranking of many users of the system. Further, the disclosed collaborative system includes features that connects raw indicator data and many detection capabilities in a cloud-based environment, while maintaining privacy of all the involved parties. Improved cyber threat detection, analysis and mitigation are obtained by integrating static analysis (e.g., code analysis) and dynamic analysis (e.g., sand boxing) to allow complementary detection of cyber threats that can be obtained through, for example, reverse engineering. The system further provides for evaluating and ranking the detection capabilities of different detection mechanisms in correlation to specific data sets, which can be the accumulated data sets. Another aspect of the disclosed embodiments relates to a secure platform for sharing/selling detection capabilities according to their past achievements and community recommendations. The disclosed system further allows the data elements and detection capabilities to be connected while keeping the anonymity of the parties.

The disclosed collaborative system enables financial, sensitive and regulated enterprises to better defend themselves by offering collaboration platform dedicated to their needs. Such system functionalities are provided in-part by a distributed, exclusive on premises network (or hosted in the cloud) that allows sharing of specific information assets (e.g., Intelligence gathering methods rather than basic attack indicator intelligence), while conforming to regulations (e.g., governmental, privacy, business, and other types of regulations) that may be imposed on particular information assets. Another feature of the disclosed system its ability to maintain data ownership by the rightful data owner, and to enforce such ownership rights and restrictions. In one implementation, the platform creates via the data ownership mechanism an operational method and processes to implement and enforce Traffic Light Protocol (TLP), which allows handling of messages based on associated permission colors of Red, Amber, Green and White, with Red having the most restrictive usage and sharing limitations, and White having the least restrictive usage and sharing criterion. Additionally, the disclosed collaborative system addresses the problem of taxonomy gap that allows seamless integration and communication of various file formats between diverse data and software platforms.

The system includes a server that interconnects with other servers to form a network to connect people and enterprises together to mutually detect and handle security issues. It is a decentralized network, includes at least two nodes that can communicate with each other. Server itself has: (1) the ability to hold and manage data related to sharing processes of data that is shared or to be shared (2) ability to send data to participants—peer to peer, broadcast, simulcast, based on data owner's decision, or prior settings (e.g., user profile). The system can further (3) manage privileges that define how (or if) another user can use the data, and (4) provide regulated sharing (i.e., the ability to manage the data based on a regulation or a set of rules. For example, the system automatically decides who can receive/share and to what extent. The system also provides (5) the ability to connect the server to another database within the enterprise (e.g., internal repository) to see if a particular data or pattern of data exists in internal repository and (6) to collect, aggregate, sort, and prioritize external data “feeds” (e.g., resources of intelligence data consumed by the enterprise). For example, when informed of a particular data pattern that has been identified as malware, the system can search an internal repository to determine if the malware pattern already exits in the repository.

The system further allows each data element to be shared (or not shared) based on a combination of permission levels that includes permissions associated with a specific user, a particular regulation, a corporate policy, or rules associated with an interest groups that the corporation is part of.

In some embodiments, each client has a server, a data repository and a framework that allows the user to utilize the server and the data repository. The client can also utilize a browser that facilitates user's interactions with the server. Additionally, or alternatively, in some implementations, an application programming interface (API) is provided to allow interactions with the system. The assets of interest (e.g., data related to security attacks, cyber activity patterns, countermeasure, etc.) can reside within (or under the control of) a organization (e.g., a corporation) or an individual or multiple entities. The assets are reachable by the users through a middleware component that is responsible for activities such as managing messages that are exchanged between users and organizations (e.g., message queuing), interlocking, which allow synchronization of data between different users, as well as providing the ability to explore who is in the network and how to reach the entities or users in the network.

The operations and features of the disclosed collaborative system can be implemented as, for example, a software, such as a virtual client that is implemented in Java, by using a VMare, which accesses the server through a mobile phone, desktop, etc., and can utilize various cloud computing and storage capabilities.

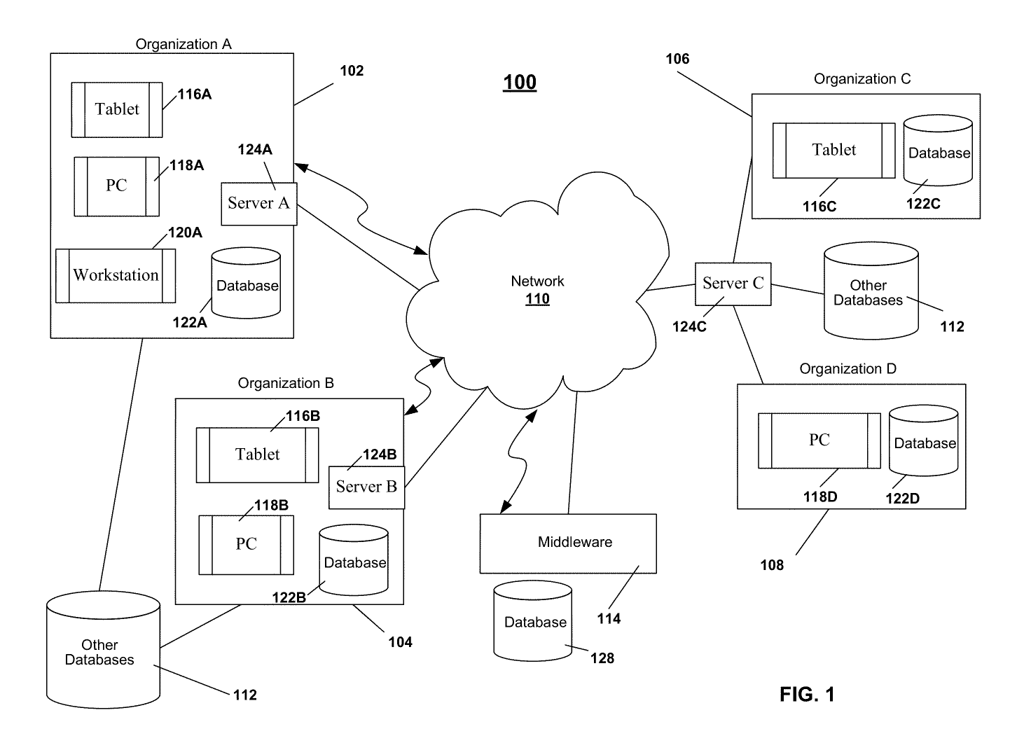

FIG. 1 provides a high level block diagram of a collaborative system 100 in accordance with the disclosed embodiments. The system 100 includes a plurality of servers 124A through 124C that can communicate with one another and with a middleware 114 component through a network 110. The middleware 114 component can be in communication with a database 128. The middleware 114 component can be incorporated as part of the infrastructure of the network 110 or can be a component separate from (and coupled to) the network 110. In the example diagram of FIG. 1, the servers 124A and 124B are part of Organization A 102 and Organization B 106, respectively, while the server 124C is shared between Organization C 106 and Organization D 108. Each of Organizations A through D 102 through 108 can include an internal database 122A through 122D, and may be in communication with one or more external databases 112 (e.g., a SIEM database that is described later in this document). Additionally, or alternatively, the organizations A through D may obtain information related to cyber threats through an interface that receives such information from an appliance such as a firewall, an anti-virus software, or other security monitoring mechanisms or protocols. Each of Organizations A through D 102 through 108 can include various computing devices that are coupled to its associated server. For example, Organization A 102 can include one or more tablets 116A, one or more PCs 118A and one or more workstations 120A. Organization B 104, on the other hand, can only use one or more tablets 116B and one or more PCs 118B, whereas Organization C 106 can use a tablet 116C and Organization D 108 can use a PC 118D. The organizations can include as many, or as few, computing devices, as needed and can range from individuals, to organizations, to even governments.

The exemplary system 100 of FIG. 1 may also include additional enterprises. In one example (not shown), an enterprise may be associated with two servers. Such a scenario, many arise, for example, in a large corporation with multiple divisions, or multiple national or international offices. In some implementation, an organization may access its associated server through a secure connection, such as when the sever is part of a private cloud that is accessible to the corresponding organization(s).

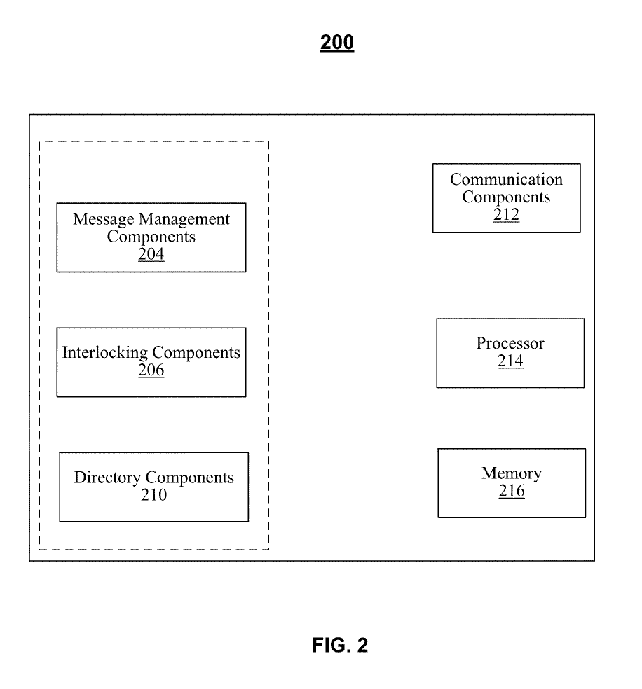

FIG. 2 illustrates a block diagram of a middleware component 200 in accordance with an exemplary embodiment. The middleware component can, for example, be the middleware component 114 that is illustrated in FIG. 1. The message management component 204 facilitates exchange of messages between different entities (e.g., collaborators) and provides various message management and control functionalities, such as message queuing. The interlocking component 206 provides synchronization between different users of the system, and the directory component 210 allows the users to determine who is using the network, and how to reach those users.

The middleware component 200 of FIG. 2 can be implemented as part of a device that includes a processor 214 and memory 216 that are in communication with each other and with other components of the device through, for example, busses, optical interconnects, wireless connections or other means of connectivity that allow the exchange of data and control signals. The processor 214 can, for example, be a microprocessor, a controller or other processing device that is known in the art. The memory 216 can be used to permanently or temporarily (e.g., as in a buffer) store data, program code, parameters or other information that can be used to configure and/or operate the device or the components therein. The communication component 212 can provide wired and/or wireless communication capabilities with other entities or networks in accordance with one or more communication protocols, and therefore they may comprise the proper transmitter/receiver, antennas, circuitry and ports, as well as the encoding/decoding capabilities that may be necessary for proper transmission and/or reception of data and other information.

Some of the aspects of the disclosed technology allows the collaborative system to be used not only for conducting collaborative research and analysis related to cyber threats, but to also utilize the system for use as a general messaging system that allows ownership of data and allows selective sharing of data.

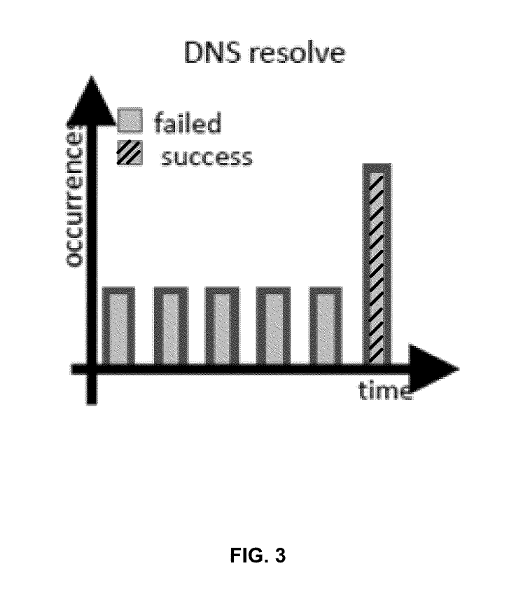

FIG. 3 shows a simplified pattern of cyber activity that can be used to illustrate how the disclosed collaborative system provides a solution to a practical problems that many enterprises face. Let's assume that an enterprise, such as a bank, obtains a hint from the FBI regarding an impending security threat. The identified threat may be a DNS, a URL, an IP address or other identifying information about the potential cyber threat. In one example, identification of the IP address may be carried out using a security information and event management (SIEM), which is a technology for real-time analysis of security alerts generated by network hardware and applications. SIEM can be software, appliances or managed services, and are also used to log security data and generate reports for compliance purposes. The bank can take the proper countermeasures to protect its assets from the cyber attack. At the same time, the bank may want to share the information about the cyber threat with other banks or other interested parties. However, the bank may not be able to freely share such information due to, for example, FBI regulations that forbids sharing of data with certain financial institutions in certain countries and regions. Moreover, attacks on other banks may be carried out using a different DNS and IP addresses and, thus, even if sharing of such information were permitted, it would not provide an effective measure to stop the cyber threat. The disclosed system of the present application, allows sharing of the pattern of attack that is launched by the DNS. For instance, as shown in FIG. 3, an example of an attack pattern can include four unsuccessful attempts by the DNS that is followed by a successful breach. Such a pattern of malicious behavior is shared with another entity (in addition to sharing of information about DNS, IP address, URL, etc.).

As noted earlier, the disclosed system can conform to particular regulations that does not allow sharing of the data with all entities within the system. For instance, in the example that was described in connection with FIG. 3, an FBI regulation may allow sharing of the IP address and URL only with other U.S. banks (and not, e.g., European banks), while allowing the sharing of other pieces of information (e.g., imminence of attack, additional information about the attack not obtained from FBI, etc.) with other entities. Using the use restriction mechanisms of the disclosed collaborative system, the bank can share be assured that it is in full conformance with the FBI regulations, since the disclosed system automatically limits the sharing of information, while allowing U.S. entities full access to such data.

The disclosed system further enables and facilitates collaboration among multiple parties to identify and provide a viable solution to a cyber attack. For example, an attack may be associated with a sophisticated attack pattern that can only be identified through collection of many data points based on attacks on several institutions. These data points can be collected using the disclosed collaborative system through observations by many collaborators and sharing of the data in real time in order to quickly and effectively identify and neutralize the cyber threat. It should be noted that one of the advantageous of the disclosed system is that there is not a central authority to aggregate and process the data. But rather, the data belongs to individual users of the system who can selectively share such information based on their preferences, regulations and other factors.

As noted earlier, the sharing of data among different entities may be subject to various regulations. For example, the Gramm-Leach-Bliley Act (GLBA) is a federal law enacted in the United States to control the ways that financial institutions deal with the private information of individuals. Health Insurance Portability and Accountability Act (HIPPA) mandates industry-wide standards for health care information on electronic billing and other processes, and requires the protection and confidential handling of protected health information. Other regulations include the European Union data protection directive (DPD) and privacy directives in both US and Europe. The disclosed collaborative system translates the applicable regulations to a set of rules (or restrictions) for sharing of data.

For each asset that is to be shared, at least three types of rules can be applied: rules based on regulations, rules based on a corporate policy, and specific rules set by the user that are applied to a specific data element. Each of the rules can set restrictions, such as with whom the data can be shared, what type of data can be shared, where the data has to be stored, who can share the data, restrictions based on geographic locations of the users and others. For example, a rule based on a specific U.S. regulation can set a condition that the data can be shared freely as long as the other entities are U.S. entities, the corporate rule can set a condition that the data owned by the corporation can be shared with any other corporation as long as the other corporation has had a predetermined number of interactions with the corporation (e.g., other corporation has shared its cyber security data at least five times), and the specific rule set by the user can set a condition that only allows sharing of data for 2 weeks.

In one exemplary embodiment, the disclosed technology enables sharing of indicators or cyber activity patterns that are likely (or are certain) to be associated with a cyber attack. Such indicators may have been produced by a first server and provided to a second server. In one implementation, one or more users of the second server can become aware of such indicators or patterns that match the second user's gathered data, but such users associated with the second server may need permission from the user(s) associated with the first server in order to access the matched data and the associated information. The following example further clarifies this aspect of the disclosed collaborative system. Assume User 1 (U1) on Server 1 (S1) creates a pattern or indicator (P). The created pattern or indicator (P) is transmitted to Sever 2 (S2), where User 2 (U2) that is associated with S2 cannot access P based on share restrictions that are established by U1. S2 performs a relevancy check (e.g., S2 checks whether P correlates with data on an appliance of U2). In one example where P is an IP address, S2 can check the logs associated with U2 to determine whether or not the culprit IP address is present. If no correlation is detected, then S2 can either stop, or alternatively, periodically (e.g., daily) perform the relevancy check. If a correlation is detected, U2 can gain access to the data (e.g., be made aware that the culprit IP address is indeed a viable threat, the extent of damage that can be caused by the threat, mitigation procedures or software, etc.). In one example, upon affirmation of a correlation, U2 can receive a message (e.g., created in advance by U1) that informs U2 that a correlation was detected and U2 can establish communications with U1 to gain access permission. It should be noted that in some implementations U2 may be granted access to only a portion of the data. By the way of example, and not by limitation, in some instances, only a data element (e.g., a “criteria” element) that is indicative that a relevancy exists is shared. The disclosed collaborative system further provides the ability to set a particular event (or sequence of events) that defines relevancy conditions. Examples of such events or sequence of events that is set by the S1 (or U1) can be: presence of a first indicator only, presence of at least two indicators, presence of two indicators, where one of the indicators is a particular indicator (e.g., indicator X). The particular mechanism as to how to allow U2 access the data can be set in advance by the U1. Similar operations can be undertaken by U2 to create indicators that can be shared with other users, such as U1.

The disclosed collaborative system is further capable of distinguishing real cyber attacks from normally-occurring cyber activities based on observed patterns of cyber activity. In one exemplary implementation, the disclosed system implements Benford's law to identify malicious cyber activities. According to Benford's law, the frequency distribution of digits in many (but not all) real-life sources of data follows a specific distribution. In particular, in a base-10 system, 1 occurs as the leading digit about 30% of the time, while larger digits occur in that position less frequently: 9 as the first digit less than 5% of the time. Benford's Law also concerns the expected distribution for digits beyond the first, which approach a uniform distribution. Thus, any cyber activity that follows the general rules of Benford's law may be considered a part of normal flow of cyber usage. However, events that fall outside of the prescribed “normal” activities can be flagged and shared, using the disclosed collaborative system, with others for further scrutiny. Additionally, or alternatively, in some exemplary implementations, other techniques for identification and/or characterization of patterns, such as techniques that describe endless patterns that can be discovered, phrased and implemented by the disclosed system, are utilized.

Another example of fraud detection is as follows: a bank notices a spike associated with fraudulent credit card transactions for credit cards that start with a particular 2-digit number (e.g., 24), all with fraudulent transaction amount of less than $5000. The fraud was detected and attributed to one employee who was responsible for issuing credit cards that started with digits 24 to his friends and family. The employee who had the authority to write off fraudulent transactions below $5000, would then write off all his friends/family credit card transactions that were less than $5000. Using the disclosed collaborative system, such a fraudulent pattern can be shared with other banks, while conforming to applicable regulations. Moreover, the sharing of such information may be restricted to only high level bank managers in order to avoid its discovery by other employees. The disclosed collaborative system thus formalizes various fraud detection techniques (e.g., statistical fraud techniques, and others) and allows sharing of advanced heuristics and strategies across the collaboration network.

The disclosed collaborative system further provides a platform for bridging the taxonomy gap that currently exists among different entities. As enterprises implement many detection strategies, research capabilities, and monitoring techniques, there is a disconnect between the various enterprises and organizations in terms of their abilities to effectively bridge the taxonomy gap between appliances (e.g., software developed by different vendors, with potentially different threat assessment/mitigation capabilities) and repositories, which prevents effective sharing of various data and information. For example, each organization may have API's, GUI's, file formats, software capabilities that make the files and information retained or discovered by one organization not accessible or not usable to other organizations. This problem is solved through the use of the disclosed collaborative system of the present application, which allows disparate systems, file formats and threat analyses to be seamlessly shared among the users of the collaborative system. To this end, the components of the disclosed technology provide translation techniques that allows the file and data that is generated using one platform, software, or operation system to other formats that can be ingested by the system and shared with various users.

In one implementation, such operations that allow interoperability between different systems and software are carried out at one or more of the servers of the system that effectuates automated conversion of queries to different databases that may be associated with a different platform or appliance—an appliance can be e.g., a data mining and analysis platform or software, such as those developed by Arcsight, Splunk, Hadoop, Cloudera, etc. For example, with reference to FIG. 1, Servers A through C (124A through 124C) can each include a translation component that provides interoperability and translation services between different platforms and files. In one example, the data indicative of cyber activities, and cyber threats that is generated by McAfee software are translated into data that is understandable by a system the uses a Symantec software.

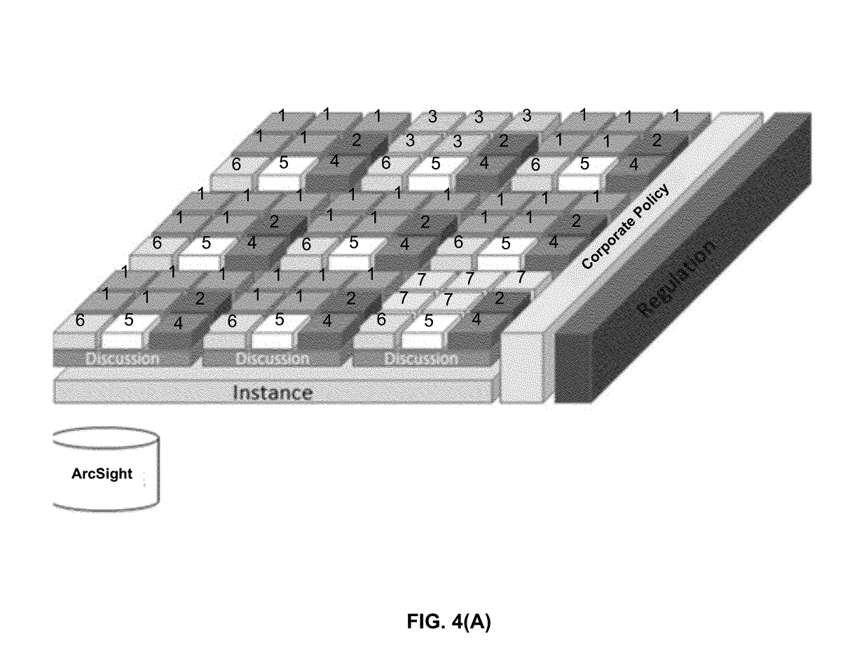

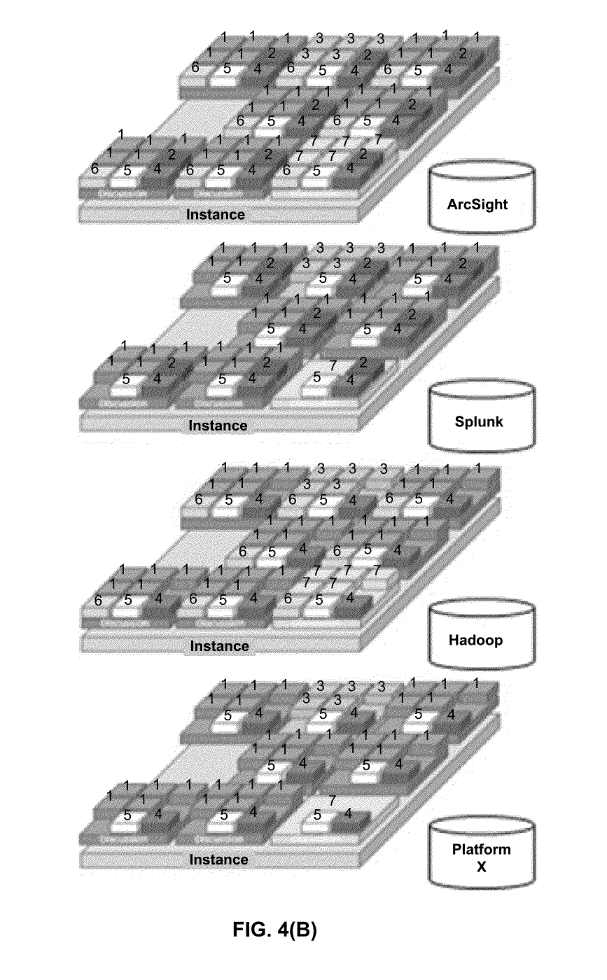

FIGS. 4(A) and 4(B) are simplified diagrams that illustrate exemplary translations capabilities of the disclosed collaborative system. These figures further illustrate examples of how such translation operations can take place seamlessly while maintaining any applicable share restriction rules. In FIG. 4(A), a particular appliance or platform (e.g., ArcSight) is shown. FIG. 4(B) shows different appliances and/or platforms (e.g., Arcsight, Splunk, Hadoop, etc.), each associated with its own database. Each of the four instances in FIG. 4(B) can also represent a particular peer that collaborates with the peer that is shown in FIG. 4(A).

FIGS. 4(A) and 4(B) illustrate that even in cases where different users utilize different appliances and technology languages, the taxonomy engine of the disclosed system can translate the data from one technology language to the other and allow sharing of data in conformance with various regulations and rules. Each small square in FIGS. 4(A) and 4(B) represents one instance of data, each medium square represents a particular discussion among two or more users or within a particular organization, and each large square (e.g., the large square labeled “instance”) represents an encapsulated data environment in which the user works with, or uses, to interact with the system. For example, each of the large squares can represent a server that is used in the system. The instances are integrated with the corporate local security appliance to achieve automation and relevancy assessment in order to avoid spam of irrelevant intelligence or attack indicators. This can all happen due to the ability of the system to incorporate regulations. For example, the lower peers can be non U.S. data that are not shared with U.S. related data elements. In each discussion, there are different data elements with different sharing permissions due to corporate policy, regulation, etc. (see, e.g., the long rectangular boxes in FIG. 4(A)). During the sharing, the different discussions are shared according to the corporate choice or external rules (e.g. regulations, sectorial arrangements etc.).

To facilitate the understanding of the operations that are carried out in FIGS. 4(A) and 4(B), different squares have been labeled with different numerical values to illustrate the different share/use restrictions that are associated with each data instance. In particular, squares that are labeled with number 1 represent general data elements with no share restrictions; squares that are labeled with number 2 represent data elements that are subject to Regulations (e.g., the regulations incorporated into the ArcSight system shown in FIG. 4(A)); squares that are labeled with number 3 represent data elements that are to be read (or seen) but not acted upon; squares that are labeled with number 4 represent security remediation tools or measures; squares that are labeled with number 5 represent the level of risk associated with the security threat in the discussion (e.g., the amount or extent of damage that was caused or is likely to be caused); squares that are labeled with number 6 represent identification information of the sender of data; and squares that are labeled with number 7 represent data elements that are subject to corporate policy (e.g., the corporate policy incorporated into the ArcSight system shown in FIG. 4(A), which allows sharing of those elements with only specific members).

The diagrams in FIG. 4(B) show example of particular data elements and/or discussions that are translated form one platform or appliance (e.g., ArcSight) into any one of several other platforms or appliances (e.g., Splunk, Hadoop, Platform X, etc.), while conforming to the applicable share restriction rules. For instance, the data elements labeled with number 6 (i.e., identity of sender in ArcSight system) is removed when data is shared with Splunk and Platform X but not when data is shared with Hadoop. Such removal is done per, for example, a user's rules that prohibits sharing of such data elements with particular peers (or even with all other peers). Further, the data elements with reference number 2 (i.e., data elements subject to Regulations) are shared with Splunk but not with Hadoop or Platform X. FIG. 4(B) further shows that data elements that are labeled with number 7 are subject to a particular corporate policy that prohibits sharing of such data with Splunk and Platform X but allows sharing with Hadoop. FIG. 4(B) also shows that one entire discussion is missing from all four platforms or peers. The missing discussion can, for example, be a particularly sensitive discussion that is not to be shared with any other entity or peer.

Another feature of the disclosed collaborative system includes enforcement and assignment of data ownership rights across the entire sharing process. In many exiting systems, once a piece of information is sent to, or shared with, another party, the other party can freely share that information with others. In those systems, the enforcement of ownership rights is often postponed to after the shared information has proliferated through, e.g., litigation at courts or other measures which are often too late to suppress the exposure of the shared information. The collaborative system of the present application solves this problem by providing data ownership rights with low level of granularity that persists with the data. For example, ownership rights are assigned and enforced for the queries to the system, the cyber attack indicators or malware indicators, the messages sent to users, the stored data, or parts of the stored data. Some of the mechanisms for asserting and enforcing data ownership includes limiting data exposure to a limited list of (trusted) participants, sharing only a smaller portion of a larger data, allowing only specific usage of data, data encryption and verification, placing time limits on sharing, storage, or usage of data and others. For example, the data owner can revoke privileges to use the data three weeks after the user has shared the data with another party.

The components or modules that are described in connection with the disclosed embodiments can be implemented as hardware, software, or combinations thereof. For example, a hardware implementation can include discrete analog and/or digital circuits that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

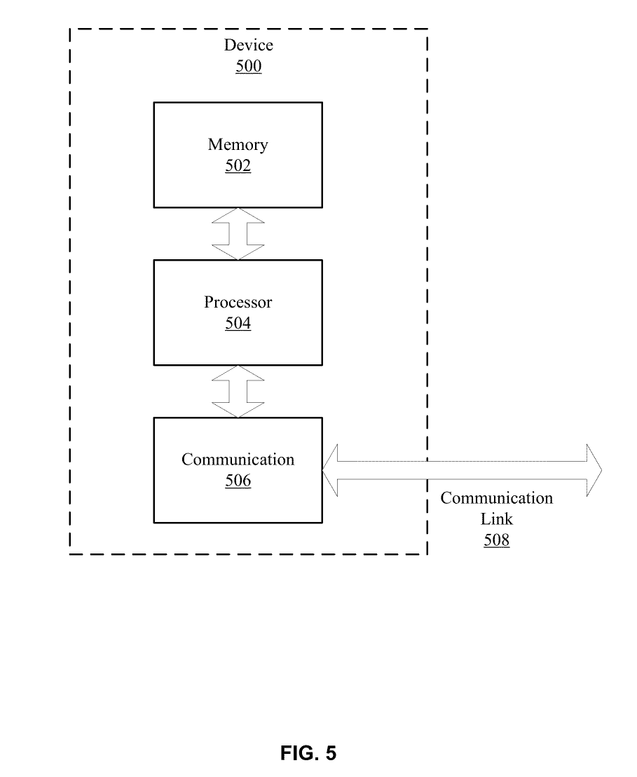

FIG. 5 illustrates a block diagram of a device 500 that can be implemented as part of the disclosed devices and systems. The device 500 comprises at least one processor 504 and/or controller, at least one memory 502 unit that is in communication with the processor 504, and at least one communication unit 506 that enables the exchange of data and information, directly or indirectly, through the communication link 508 with other entities, devices, databases and networks. The communication unit 506 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 500 of FIG. 5 may be integrated as part of any devices or components to perform any of the disclosed methods.

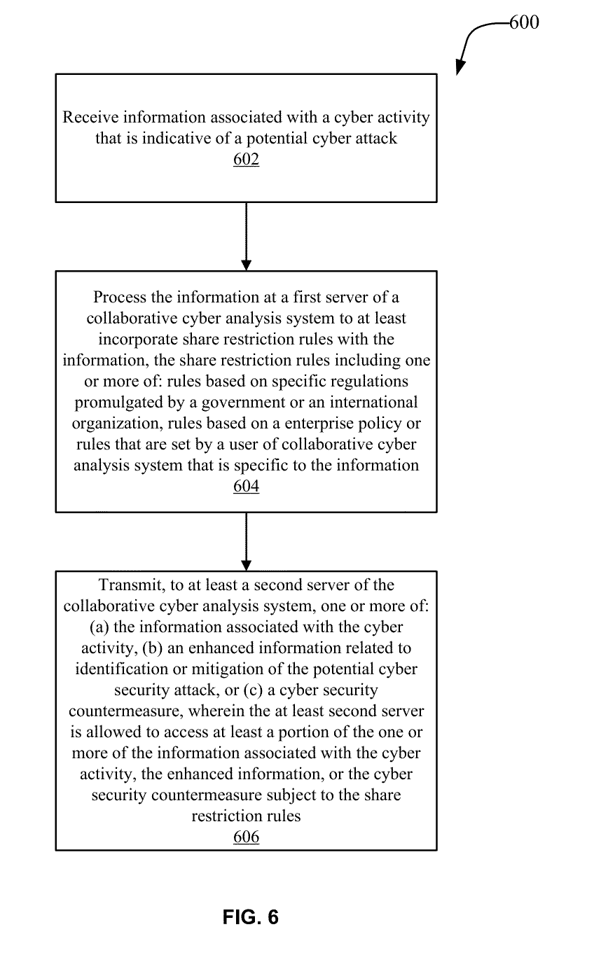

FIG. 6 illustrates a set of exemplary operations 600 that can be carried out to collaboratively evaluate cyber security threats in accordance with an exemplary embodiment. At 602, information associated with a cyber activity is received that is indicative of a potential cyber attack. At 604, the information is processed at a first server of a collaborative cyber analysis system to at least incorporate share restriction rules with the information. The share restriction rules include one or more of: rules based on specific regulations promulgated by a government or an international organization, rules based on a enterprise policy or rules that are set by a user of collaborative cyber analysis system that are specific to the information. At 606, one or more of the following is transmitted to at least a second server of the collaborative cyber analysis system: (a) the information associated with the cyber activity, (b) an enhanced information related to identification or mitigation of the potential cyber security attack, or (c) a cyber security countermeasure. The at least second server is allowed to access at least a portion of the one or more of the information associated with the cyber activity, the enhanced information, or the cyber security countermeasure subject to the share restriction rules.

The operations that are described in FIG. 6 for collaboratively evaluating cyber security threats can be augmented using the following exemplary embodiment. For instance, in one exemplary embodiment, the share restriction rules can be automatically incorporated into all data or messages related to the information associated with a cyber activity that are transmitted from, or stored at, the first server so that at least one segment of the information, the enhanced information, or the cyber security countermeasure is not assessable to a first party while the at least one segment is accessible to a second party. In another exemplary embodiment, the rules based on enterprise policy automatically incorporate access restriction mechanisms to all data or messages that are stored at, transmitted from, or access from a specific enterprise. For instance, the rules based on the enterprise policy permit sharing of the information, the enhanced information, or the cyber security countermeasure by the specific enterprise with a second enterprise which has had a predetermined number of interactions with the specific enterprise.

According to another exemplary embodiment, the rules that are set by the user incorporate a time-based access restriction that allows access for a predetermined time interval to one or more of the information, the enhanced information, or the cyber security countermeasure. In yet another exemplary embodiment, the processing comprises: ascertaining at least one of: (a) an identity of a source of the potential cyber attack, (b) the degree of damage to a networked computing system or to stored information that can be caused by the potential cyber attack, or (c) a specific pattern of cyber activity associated with the potential cyber attack; and then producing at least a portion of the enhanced information based on items (a), (b) or (c).

In one exemplary embodiment, the cyber activity is associated with a software program, and the processing includes using a virtualization system to conduct a static analysis of the software program and a dynamic analysis of the software program, and combining a result of the static analysis with a result of the dynamic analysis to produce at least a portion of the enhanced information. In particular, the dynamic analysis can be conducted using a sandbox to execute the software program to identify a malicious behavior.

According to another exemplary embodiment, the above method for collaboratively evaluating cyber security threats further includes receiving additional information from at least the second server at the first server, the additional information having been produced based on one or more of the information associated with a cyber activity, the enhanced information, or the cyber security countermeasure that were transmitted to at least the second server. Such additional information provide further data that facilitates one or more of: identification of a source of the potential cyber attack, a degree of damage to a networked computing system or to stored information that can be caused by the potential cyber attack, or a specific pattern of cyber activity associated with the potential cyber attack.

In another exemplary embodiment, the above method for collaboratively evaluating cyber security threats further includes receiving additional information at the first server from a plurality of other servers in the collaborative security analysis system, where the processing of the information includes combing the additional information with the received information associated with the cyber activity according to past achievements or recommendations associated with the additional information. In still another embodiment, the information associated with the cyber activity is received from a database. For example, the database can be associated with security information and event management (SIEM). The information associated with the cyber activity can additionally, or alternatively, be received through an interface that is coupled to a security appliance operable to produce at least information indicative of a cyber threat. In yet another exemplary embodiment, the specific regulations promulgated by a government or an international organization include rules that are in conformance with one or more of: Gramm-Leach-Bliley Act (GLBA) or Health Insurance Portability and Accountability Act (HIPPA).

In another exemplary embodiment, the share restriction rules restrict access to one or more of the received information associated with the cyber activity, the enhanced information, or the cyber security countermeasure based on a type of data that is targeted by the potential cyber attack and based an affiliation of a recipient of the information, the enhanced information, or the cyber security countermeasure. In one specific example, the type of data is financial data, the affiliation of the recipient is one or a United States entity or a non-United States entity, and the share restriction rules forbid sharing of the one or more of the information, the enhanced information, or the cyber security countermeasure regarding the potential cyber attack on the financial data with all non-United States entities. In another exemplary embodiment, the rules based on specific regulations promulgated by a government or an international organization, the rules based on a enterprise policy, or the rules that are set by a user of collaborative cyber analysis system include privacy considerations. In yet another exemplary embodiment, the processing of the received information associated with the cyber activity includes performing a statistical testing on the information to determine a pattern of cyber activity that is associated with the potential cyber attack.

In another exemplary embodiment, cyber activity data associated with a user of the second server is processed by the second server to determine whether or not a correlation between the data associated with the user of the second server and one or more of the information associated with the cyber activity or the enhanced information related to identification or mitigation of the potential cyber security attack exists. Upon a determination that a correlation exists, the user of the second server is allowed access to the information associated with the cyber activity or the enhanced information related to identification or mitigation of the potential cyber security attack only upon a determination that access privileges established by a user of the first server allow the user of the second server to access the information associated with the cyber activity or the enhanced information.

In one exemplary embodiment, one or more of the information associated with the cyber activity, the enhanced information, or the cyber security countermeasure is in a first format that is compatible with a first cyber security system, and the above noted process that is described in FIG. 6 includes transmitting one or more of the information, the enhanced information, or the cyber security countermeasure in the first format to the second server that includes translation component configured to translate one or more of the information, the enhanced information, or the cyber security countermeasure to a second format that is compatible with a second cyber security system.

According to another embodiment, the processing at operation 604 of FIG. 6 includes searching and retrieving from a repository previously stored data associated with the cyber activity, and combining the received information associated with the cyber activity with the previously stored data to produce the enhanced information. In yet another exemplary embodiment, the share restriction rules prohibit sharing of an identification of a user of the collaborative cyber analysis system. In one exemplary embodiment, the share restriction rules are enforced by all entities of the collaborative cyber analysis system, while in another exemplary embodiment, the share restriction rules enable ownership of one or more of the information associated with the cyber activity, the enhanced information, or the cyber security countermeasure to be maintained throughout the collaborative cyber analysis system. In one exemplary embodiment, the share restriction rules further include a provision for receiving monetary compensation in exchange for allowing the information to be shared with another entity.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In particular, one aspect of the disclosed embodiments relates to a computer program product, stored on one or more non-transitory computer readable media. The computer program produce includes program code for receiving information associated with a cyber activity that is indicative of a potential cyber attack, and program code for processing the information at a first server of a collaborative cyber analysis system to at least incorporate share restriction rules with the information. The share restriction rules including one or more of: rules based on specific regulations promulgated by a government or an international organization, rules based on a enterprise policy or rules that are set by a user of collaborative cyber analysis system that are specific to the information. The computer program product further includes program code for transmitting, to at least a second server of the collaborative cyber analysis system, one or more of: (a) the information associated with the cyber activity, (b) an enhanced information related to identification or mitigation of the potential cyber security attack, or (c) a cyber security countermeasure, where the at least second server is allowed to access at least a portion of the one or more of the information associated with the cyber activity, the enhanced information, or the cyber security countermeasure subject to the share restriction rules.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

What is claimed is:

1. A method for collaborative evaluation of cyber security threats, the method comprising:
receiving information associated with a cyber activity that is indicative of a potential cyber attack;
processing the information at a first server of a collaborative cyber analysis system to at least incorporate share restriction rules with the information, the share restriction rules including one or more of: rules based on specific regulations promulgated by a government or an international organization, rules based on a enterprise policy or rules that are set by a user of collaborative cyber analysis system that are specific to the information; and
transmitting, to at least a second server of the collaborative cyber analysis system, one or more of: (a) the information associated with the cyber activity, (b) an enhanced information related to identification or mitigation of the potential cyber security attack, or (c) a cyber security countermeasure, wherein the at least second server is allowed to access at least a portion of the one or more of the information associated with the cyber activity, the enhanced information, or the cyber security countermeasure subject to the share restriction rules.

2. The method of claim 1, wherein the transmitting comprises automatically applying the share restriction rules to all data or messages related to the information that are transmitted from, or stored at, the first server so that at least one segment of the information, the enhanced information, or the cyber security countermeasure is not assessable to a first party while the at least one segment is accessible to a second party.

3. The method of claim 1, wherein the rules based on enterprise policy automatically incorporate access restriction mechanisms to all data or messages that are stored at, transmitted from, or access from a specific enterprise.

4. The method of claim 3, wherein the rules based on the enterprise policy permit sharing of the information, the enhanced information, or the cyber security countermeasure by the specific enterprise with a second enterprise which has had a predetermined number of interactions with the specific enterprise.

5. The method of claim 1, wherein the rules that are set by the user incorporate a time-based access restriction that allows access for a predetermined time interval to one or more of the information, the enhanced information, or the cyber security countermeasure.

6. The method of claim 1, further comprising subsequent to incorporation of the share restriction rules, revoking an access privilege to one or more of the information associated with the cyber activity, the enhanced information related to identification or mitigation of the potential cyber security attack, or the cyber security countermeasure.

7. The method of claim 1, wherein the processing comprises:
ascertaining at least one of:
(i) an identity of a source of the potential cyber attack,
(ii) the degree of damage to a networked computing system or to stored information that can be caused by the potential cyber attack, or
(iii) a specific pattern of cyber activity associated with the potential cyber attack; and
producing at least a portion of the enhanced information based on items (a), (b) or (c).

8. The method of claim 1, wherein
the cyber activity is associated with a software program, and
the processing comprises using a virtualization system to conduct a static analysis of the software program and a dynamic analysis of the software program, and
combining a result of the static analysis with a result of the dynamic analysis to produce at least a portion of the enhanced information.

9. The method of claim 8, wherein the dynamic analysis is conducted using a sandbox to execute the software program to identify a malicious behavior.

10. The method of claim 1, further comprising:
receiving additional information from at least the second server at the first server, the additional information having been produced based on one or more of the information associated with a cyber activity, the enhanced information, or the cyber security countermeasure that were transmitted to at least the second server, the additional information providing further data that facilitates one or more of: identification of a source of the potential cyber attack, a degree of damage to a networked computing system or to stored information that can be caused by the potential cyber attack, or a specific pattern of cyber activity associated with the potential cyber attack.

11. The method of claim 1, further comprising:
receiving additional information at the first server from a plurality of other servers in the collaborative security analysis system, wherein
the processing comprises combing the additional information with the received information associated with the cyber activity according to past achievements or recommendations associated with the additional information to produce at least a portion of the enhanced information.

12. The method of claim 1, wherein the information associated with the cyber activity is received from a database.

13. The method of claim 12, wherein the database is associated with security information and event management (SIEM).

14. The method of claim 1, wherein the information associated with the cyber activity is received through an interface that is coupled to a security appliance operable to produce at least information indicative of a cyber threat.

15. The method of claim 1, wherein the specific regulations promulgated by a government or an international organization include rules that are in conformance with one or more of: Gramm-Leach-Bliley Act (GLBA), Health Insurance Portability and Accountability Act (HIPPA), European Union's data protection directive (DPD), or a U.S. or a European Union privacy regulation.

16. The method of claim 1, wherein the share restriction rules restrict access to one or more of the information, the enhanced information, or the cyber security countermeasure based on a type of data that is targeted by the potential cyber attack and based on an affiliation of a recipient of the information, the enhanced information, or the cyber security countermeasure.

17. The method of claim 16, wherein the type of data is financial data, the affiliation of the recipient is one or a United States entity or a non-United States entity, and the share restriction rules forbid sharing of the one or more of the information, the enhanced information, or the cyber security countermeasure regarding the potential cyber attack on the financial data with all non-United States entities.

18. The method of claim 1, wherein the rules based on specific regulations promulgated by a government or an international organization, the rules based on a enterprise policy, or the rules that are set by a user of collaborative cyber analysis system include privacy considerations.

19. The method of claim 1, wherein the processing includes performing a statistical testing on the information to determine a pattern of cyber activity that is associated with the potential cyber attack.

20. The method of claim 1, wherein:
one or more of the information, the enhanced information, or the cyber security countermeasure is in a first format that is compatible with a first cyber security system; and
the second server uses a translation component to translate one or more of the information, the enhanced information, or the cyber security countermeasure to a second format that is compatible with a second cyber security system.

21. The method of claim 1, wherein the processing comprises:
searching a repository and retrieving from the repository previously stored data associated with the cyber activity; and
combining the received information associated with the cyber activity with the previously stored data to produce the enhanced information.

22. The method of claim 1, wherein the share restriction rules prohibit sharing of an identify of a user of the collaborative cyber analysis system.

23. The method of claim 1, wherein the share restriction rules are enforced by all entities of the collaborative cyber analysis system.

24. The method of claim 1, wherein the share restriction rules enable ownership of one or more of the information, the enhanced information, or the cyber security countermeasure to be maintained throughout the collaborative cyber analysis system.

25. The method of claim 1, wherein the share restriction rules further include a provision for receiving monetary compensation in exchange for allowing the information to be shared with another entity.

26. The method of claim 1, further comprising:
processing, at the second sever, cyber activity data associated with a user of the second server to determine whether or not a correlation between the data associated with the user of the second server and one or more of the information associated with the cyber activity or the enhanced information related to identification or mitigation of the potential cyber security attack exists; and
upon a determination that a correlation exists, allowing the user of the second server access to at least part of the information associated with the cyber activity or the enhanced information related to identification or mitigation of the potential cyber security attack only upon a determination that access privileges established by a user of the first server allow the user of the second server to access the at least part of the information associated with the cyber activity or the enhanced information.

27. A computer program product, stored on one or more non-transitory computer readable media, comprising:
program code for receiving information associated with a cyber activity that is indicative of a potential cyber attack;
program code for processing the information at a first server of a collaborative cyber analysis system to at least incorporate share restriction rules with the information, the share restriction rules including one or more of: rules based on specific regulations promulgated by a government or an international organization, rules based on a enterprise policy or rules that are set by a user of collaborative cyber analysis system that are specific to the information; and
program code for transmitting, to at least a second server of the collaborative cyber analysis system, one or more of: (a) the information associated with the cyber activity, (b) an enhanced information related to identification or mitigation of the potential cyber security attack, or (c) a cyber security countermeasure, wherein the at least second server is allowed to access at least a portion of the one or more of the information associated with the cyber activity, the enhanced information, or the cyber security countermeasure subject to the share restriction rules.

28. The computer program product of claim 27, further comprising program code for automatically applying the share restriction rules to all data or messages related to the information that are transmitted from, or stored at, the first server so that at least one segment of the information, the enhanced information, or the cyber security countermeasure is not assessable to a first party while the at least one segment is accessible to a second party.

29. The computer program product of claim 27, wherein the rules based on enterprise policy automatically incorporate access restriction mechanisms to all data or messages that are stored at, transmitted from, or access from a specific enterprise.

30. The computer program product of claim 29, wherein the rules based on the enterprise policy permit sharing of the information, the enhanced information, or the cyber security countermeasure by the specific enterprise with a second enterprise which has had a predetermined number of interactions with the specific enterprise.

31. The computer program product of claim 27, wherein the rules that are set by the user incorporate a time-based access restriction that allows access for a predetermined time interval to one or more of the information, the enhanced information, or the cyber security countermeasure.

32. The computer program product of claim 27, further comprising program code for, subsequent to incorporation of the share restriction rules, revoking an access privilege to one or more of the information associated with the cyber activity, the enhanced information related to identification or mitigation of the potential cyber security attack, or the cyber security countermeasure.

33. The computer program product of claim 27, wherein the processing comprises:
ascertaining at least one of:
(i) an identity of a source of the potential cyber attack,
(ii) the degree of damage to a networked computing system or to stored information that can be caused by the potential cyber attack, or
(iii) a specific pattern of cyber activity associated with the potential cyber attack; and
producing at least a portion of the enhanced information based on items (a), (b) or (c).

34. The computer program product of claim 27, wherein
the cyber activity is associated with a software program, and
the processing comprises using a virtualization system to conduct a static analysis of the software program and a dynamic analysis of the software program, and
combining a result of the static analysis and a result of the dynamic analysis to produce at least a portion of the enhanced information.

35. The computer program product of claim 34, wherein the dynamic analysis is conducted using a sandbox to execute the software program to identify a malicious behavior.

36. The computer program product of claim 27, further comprising:
program code for receiving additional information from at least the second server at the first server, the additional information having been produced based on one or more of the information associated with a cyber activity, the enhanced information, or the cyber security countermeasure that were transmitted to at least the second server, the additional information providing further data that facilitates one or more of: identification of a source of the potential cyber attack, a degree of damage to a networked computing system or to stored information that can be caused by the potential cyber attack, or a specific pattern of cyber activity associated with the potential cyber attack.

37. The computer program product of claim 27, further comprising:
program code for receiving additional information a the first server from a plurality of other servers in the collaborative security analysis system, wherein
the processing comprises combing the additional information with the received information associated with the cyber activity according to past achievements or recommendations associated with the additional information to produce at least a portion of the enhanced information.

38. The computer program product of claim 27, wherein the information associated with a cyber activity is received from a database.

39. The computer program product of claim 38, wherein the database is associated with security information and event management (SIEM).

40. The computer program product of claim 27, wherein the information associated with the cyber activity is received through an interface that is coupled to a security appliance operable to produce at least information indicative of a cyber threat.

41. The computer program product of claim 27, wherein the specific regulations promulgated by a government or an international organization include rules that are in conformance with one or more of: Gramm-Leach-Bliley Act (GLBA), Health Insurance Portability and Accountability Act (HIPPA), European Union's data protection directive (DPD), or a U.S. or a European Union privacy regulation.

42. The computer program product of claim 27, wherein the share restriction rules restrict access to one or more of the information, the enhanced information, or the cyber security countermeasure based on a type of data that is targeted by the potential cyber attack and based on an affiliation of a recipient of the information, the enhanced information, or the cyber security countermeasure.

43. The computer program product of claim 42, wherein the type of data is financial data, the affiliation of the recipient is one or a United States entity or a non-United States entity, and the share restriction rules forbid sharing of the one or more of the information, the enhanced information, or the cyber security countermeasure regarding the potential cyber attack on the financial data with all non-United States entities.

44. The computer program product of claim 27, wherein the rules based on specific regulations promulgated by a government or an international organization, the rules based on a enterprise policy, or the rules that are set by a user of collaborative cyber analysis system include privacy considerations.

45. The computer program product of claim 27, wherein the program code for processing includes program code for performing a statistical testing on the information to determine a pattern of cyber activity that is associated with the potential cyber attack.

46. The computer program product of claim 27, wherein:
one or more of the information, the enhanced information, or the cyber security countermeasure is in a first format that is compatible with a first cyber security system; and
the second server includes program code for translating one or more of the information, the enhanced information, or the cyber security countermeasure into a second format that is compatible with a second cyber security system.

47. The computer program product of claim 27, wherein the processing comprises:
searching a repository and retrieving from the repository previously stored data associated with the cyber activity; and
combining the received information associated with the cyber activity with the previously stored data to produce the enhanced information.

48. The computer program product of claim 27, wherein the share restriction rules prohibit sharing of an identify of a user of the collaborative cyber analysis system.

49. The computer program product of claim 27, wherein the share restriction rules are enforced by all entities of the collaborative cyber analysis system.

50. The computer program product of claim 27, wherein the share restriction rules enable ownership of one or more of the information, the enhanced information, or the cyber security countermeasure to be maintained throughout the collaborative cyber analysis system.

51. The computer program product of claim 27, wherein the share restriction rules further include a provision for receiving monetary compensation in exchange for allowing the information to be shared with another entity.

52. The computer program product of claim 27, further comprising:
program code for processing, at the second sever, cyber activity data associated with a user of the second server to determine whether or not a correlation between the data associated with the user of the second server and one or more of the information associated with the cyber activity or the enhanced information related to identification or mitigation of the potential cyber security attack exists; and
program code for, upon a determination that a correlation exists, allowing the user of the second server access to at least part of the information associated with the cyber activity or the enhanced information related to identification or mitigation of the potential cyber security attack only upon a determination that access privileges established by a user of the first server allow the user of the second server to access the at least part of the information associated with the cyber activity or the enhanced information.

53. A device, comprising:
a processor; and
a memory comprising processor executable code, the processor executable code, when executed by the processor, configures that device to:
receive information associated with a cyber activity that is indicative of a potential cyber attack;
process the information at a first server of a collaborative cyber analysis system to at least incorporate share restriction rules with the information, the share restriction rules including one or more of: rules based on specific regulations promulgated by a government or an international organization, rules based on a enterprise policy or rules that are set by a user of collaborative cyber analysis system that are specific to the information; and
transmit, to at least a second server of the collaborative cyber analysis system, one or more of: (a) the information associated with the cyber activity, (b) an enhanced information related to identification or mitigation of the potential cyber security attack, or (c) a cyber security countermeasure, wherein the at least second server is allowed to access at least a portion of the one or more of the information associated with a cyber activity, the enhanced information, or the cyber security countermeasure subject to the share restriction rules.

54. A system for collaborative evaluation of cyber security threats, the comprising:
a first server coupled to one or more computing devices of a first enterprise, the first server further coupled to a communication network to receive information associated with a cyber activity that is indicative of a potential cyber attack, the first server further including a processor to process the information to at least incorporate share restriction rules with the information, the share restriction rules including one or more of: rules based on specific regulations promulgated by a government or an international organization, rules based on a enterprise policy or rules that are set by a user of collaborative cyber analysis system that is specific to the information, and to transmit the processed information to a second server; and
the second server coupled to the communication network to receive one or more of: (a) the information associated with the cyber activity, (b) an enhanced information related to identification or mitigation of the potential cyber security attack, or (c) a cyber security countermeasure, wherein the second server is allowed to access at least a portion of the one or more of the information associated with the cyber activity, the enhanced information, or the cyber security countermeasure subject to the share restriction rules.

55. The system of claim 54, wherein the middleware component is configured to manage queuing or routing of messages that are exchanged between the first server and other entities of the system, including the second server.

56. The system of claim 55, wherein the middleware component is further configured to, prior to routing the messages to the second sever, remove an identity associated with the messages that is transmitted by the first server.

57. The system of claim 55, wherein the middleware component is configured to provide a directory of users, servers or enterprises associated with the system for collaborative evaluation of cyber security threats.

58. The system of claim 55, wherein the middleware component includes an interlocking subcomponent to synchronize data amongst different servers, or different users of the system.
